(19) United States
(12) Patent Application Publication
(10) Pub. No.: US 2005/0283418 A1
(43) Pub. Date: Dec. 22, 2005

(54) System and methodology for processing debt management plans

(76) Inventors: John R. Thornborough, Granville, OH (US); William Cullinan, Landenberg, PA (US)

Correspondence Address: Charles B. Lobsenz;Roberts, Mlotkowski & Hobbes, PC, Suite 850, 8270 Greensboro Drive, McLean, VA, 22102, US

(21) Appl. No.: 11/155,173

(22) Filed: Jun. 17, 2005

Related U.S. Application Data
(60) Provisional application No. 60/581,247, filed on Jun. 18, 2004.

(51) Int. Cl. G06F 17/60

(52) U.S. Cl. 705/35

(57) ABSTRACT

A system and method for creating and managing debt management plans on an automated basis. The system is provided with various personal and financial information from a debtor and/or a credit counselor and then automatically generates a debt management plan for the debtor subject to creditor approval. In one embodiment, each of the creditors is provided with the specifics of the proposed debt management plan and may approve it, reject it or approve it conditionally. Once finally accepted, the system can implement the debt management plan on behalf of the debtor, creditor and credit counseling agency. In one embodiment, a DMP score may also be associated with each debt management plan indicative of the attractiveness of the plan to the creditors. It is also possible for each individual creditor to influence the calculation of the DMP scoring by adjusting weightings of multiple factors associated with the DMP.

### BACKGROUND

1. Field of the Invention

The present invention relates generally to the credit industry and more particularly to systems and processes for managing consumer debt.

2. Background of the Invention

Creditors in the United States, including banks, savings and loan societies, credit unions, retailers, etc., have been in the business of lending to consumers for about a century; however, unsecured lending in volume is a much more recent phenomenon. Prior to World War II, the vast majority of lending to consumers was secured—by mortgages, primarily, and to a lesser extent by purchased automobiles and appliances. After the war, returning veterans, their families, and the general public that had endured shortages of consumer goods for several years clamored for new or expanded housing, automobiles, appliances, televisions, and other material items.

Within five years after the end of the war, creditors began to see increased levels of delinquency throughout their portfolios. Senior credit executives who studied the problem concluded that credit education was an essential component of the lending process, yet it was generally not available to consumers. Their thesis was that credit-educated consumers would understand the applicability of various types of credit to their individual situations; use household budgeting techniques to plan and manage their spending; prepare for financial contingencies; and, in general, use credit wisely to enrich their lives, while still living within their means.

Accordingly, in 1951 a number of the largest consumer lenders in the country participated in the development of a not-for-profit credit education organization dedicated to consumers. This entity, the forerunner of today's National Foundation for Credit Counseling (NFCC), offered credit advice and information, mainly through its creditor founders, to current and prospective borrowers for the next fifteen or so years. In the mid-1960s, the organization's mission expanded to include providing “debt management plans”, or “DMPs”, through NFCC Member Agencies to those consumers who were in financial distress and unable to manage their fiscal responsibilities without assistance. These “Member Agencies” were independent non-profits, mostly part of social service agencies in their local communities, which adhered to the guidelines and principles of the NFCC. Over the next three decades, the NFCC expanded its services nationally, eventually sponsoring approximately 200 Member Agencies with over 1,200 local offices. During those years, the NFCC and its affiliates represented at least 90% of the credit counseling industry nationwide.

In 1994, several competing counseling agencies initiated a lawsuit against the NFCC, alleging anti-competitive measures and restraint of trade violations. The suit was settled the several years later but, nevertheless, this event was a watershed moment for the industry. Prior to the suit, creditors dealt almost exclusively with the NFCC and its affiliates in the credit counseling industry primarily because there was little competition, but also because creditors had started and supported the organization for more than four decades. Now, however, creditors became more attuned to new entrants into the industry and offered support similar to that given to the NFCC as long as the counseling agency proved their not-for-profit status.

Over the next five or more years, literally hundreds of new credit counseling agencies arose in the United States. Some were well-funded, sophisticated operations, others were “mom and pop” businesses operated out of homes. The quality of the counseling offered by these start-ups ranges from very good to almost non-existent, according to creditors familiar with their practices. Today, it is believed there are more than 1,500 agencies doing business in the U.S. The NFCC's membership rolls have been reduced during this period to approximately 125 Member Agencies with about 1,000 offices, due primarily to mergers within the ranks as a result of weakened financial positions. Today, the NFCC represents only about 20% of the volume of DMPs generated by the industry, and most of the largest agencies in the industry are non-NFCC members.

There does not exist a credit counseling industry association or trade group representing all, or even a sizeable fraction of counseling agencies. However, it is believed that there are now more than 1,500 counseling agencies (the number of offices is less well known, but may approximate 3,000), and approximately one and one-half million DMPs are accepted by creditors yearly. The “typical” consumer seeking debt relief today through a counseling agency has 10 unsecured accounts, including credit cards, retail store cards, oil company accounts, and past-due communications and utility bills. Accordingly, about 15 million accounts are likely to be included in the industry-wide annual total of new DMPs.

While much information about DMPs is not gathered centrally, nor do agencies or creditors share confidential or proprietary data, it is known that the “typical” consumer currently considering this type of action has non-mortgage debts amounting to approximately $30,000. In some instances, this may include an automobile, boat, or recreational vehicle loan, but exact breakdowns between secured and unsecured loans are not available across the industry. It is believed, however, that about 80% of this average debt is unsecured. Extrapolating the data, therefore, indicates approximately $36 billion of unsecured debt held by consumers is accepted by creditors into new DMPs yearly (1,500,000×$30,000×80%).

Counseling agencies historically received income from participating creditors only, although in some cases local funding was available from a social service agency or local partner such as the United Way, Lutheran Social Services, Catholic Charities, etc. Agencies might also have received financial assistance from local creditors, credit bureaus, and the like, but generally never charged fees to the consumers seeking help. Creditors participating in DMPs normally made donations to agencies in the form of “Fair Share” payments. The standard rate for decades was 15% of amounts recovered by the agencies from the consumers and remitted to the creditors.

During the early 1990s, this funding scenario began to change. Initially, several large creditors challenged the industry to become more efficient in back room operations through the use of automation, as well as consolidations. To reinforce their positions, the creditors lowered the “Fair Share” rate they were willing to pay to 12%. By mid-decade, this trend had become, more or less, the industry standard, and counseling agencies indeed had become more efficient. It was during this period, however, that some agencies began to assess small fees to their clients, the consumer debtors, if the agencies' own financial security was at risk. These fees were relatively small, e.g., $5-10 per month for handling and processing payments to creditors, and were typically waived in hardship situations.

As a result of the aforementioned lawsuit in the mid-1990s new entrants came into the industry and two things happened: the volume of DMPs increased, and creditors responded in part by further reducing “Fair Share” rates. These trends accelerated to the point that by the early 2000s, the number of new DMPs greatly outpaced the growth both in creditors' receivables and in delinquent accounts, and creditors were, on average, paying about 8% of recoveries to the industry. While there are no authoritative figures, it is estimated that today creditors spend as much as $1 billion annually in “Fair Share” payments.

From a financial standpoint, however, the “Fair Share” payments made by creditors to the credit counseling industry represent only part of their cost of supporting DMPs. Of greater financial import is the cost of concessions creditors make to their customers when they accept a DMP proposal from a credit counseling agency. These concessions may include reducing or waiving future interest charges and late payment/over the credit line fees, accepting smaller payments than contractually required and agreeing not to take collection action even though the accounts normally are delinquent, or some combination of these concessions. While measurable from a specific creditor's standpoint, account by account, there is no centralized way to calculate the true cost to creditors of all concessions made under DMPs. It is believed, however, that they are at least twice the cost of “Fair Share” payments, or perhaps $2 billion annually.

In addition to these substantial amounts, managing accounts in the debt management process and relationships with the more than 1,500 players in the industry is also expensive and difficult for creditors. With varying policies, practices and procedures employed, creditors have vastly different staffing requirements. However, it is known that at least one large creditor spends more than $2 million annually in staffing for DMP processing.

DMPs represent a great benefit to the industry although the processing thereof is not without its difficulties. According to the process, consumers in financial difficulty who are seeking assistance contact credit counseling agencies for help. They may find agencies through referrals by relatives, friends, employers, creditors, and social service organizations or they may respond to advertising, including print, local radio and more and more frequently now, television. Traditionally, after calling for an appointment, a consumer and/or the family would visit the agency in person to review and assess their situation with a trained counselor. With the advent of the internet, and the widespread use of toll-free telecommunications in customer service, in-person counseling is no longer the norm.

However the service is delivered, the substance should remain the same. That is, a trained counselor should review the client's situation, make recommendations specific to the client's situation and, if the client agrees, proceeds with a debt management plan. The common denominator among methods for providing the service should be that there is sufficient time to gather and assess all pertinent information during the counseling session. Most legitimate counselors will agree that a quality session takes at least one hour, frequently more.

Throughout the history of the credit counseling industry, legitimate members (defined as those who are truly non-profit, employ appropriately trained personnel, and work in the best interests of the consumers) have found that not all clients are best served by being enrolled in a DMP. For instance, approximately ⅓ of applicants have underlying issues that have to be resolved before the financial situation can be addressed. Examples here include people with alcohol or chemical dependencies, gambling problems, or other conditions requiring professional intervention; people without adequate housing; people whose only true recourse is to see an attorney to discuss possible bankruptcy proceedings; etc. In addition, another sub-group of applicants (the percentage varies from about 25% to about 35% depending upon, among other things, the state of the economy) requires only financial education and guidance to be able to manage within their means. In other words, these consumers may need help constructing a budget, preparing a family financial plan, and benefit from a counselor's recommendations as to reducing expenses and increasing income.

It is the final ⅓ of a legitimate agency's inflow of customers who truly need a DMP to survive the financial predicament they are in. Creditors historically have been willing to support these customers by accepting debt management plans, because they respect the customers' resolve to honor their debts, and because they know that the likelihood of further delinquency or write-off will increase if the customer is refused the aid. The creditors have relied upon the credit counseling industry to properly screen clients so that only those truly needing the assistance given through a DMP would be proffered to them, and in turn supported the industry in a form of “partnership” to assist consumers.

One of the tenets of the creditor/agency industry relationship over the years is that when counseling is conducted, all pertinent information should be recorded and evaluated, including all debts. Creditors rightfully take the position that without full information, correct decisions cannot be made. While all large creditors, and many mid-size and small ones as well, support credit counseling, others don't. Those who do are willing to subsidize the others in the belief that it is in their and their customers' best interests to do so when a DMP clearly is in order. Agencies will typically include debt on plans owed to creditors who did not support them and they will also send payments to those creditors on behalf of their clients, to ensure the success of the plans and because the willing creditors cover their expenses.

When DMPs are approved by creditors, agencies collect agreed upon amounts monthly from the customers and then distribute the appropriate sums to each creditor on the plan. The effect of this process, if maintained regularly, is twofold. First, the customers only have to deal with the agency, not with the typical 10 or so different creditors to which they are indebted (this is most helpful in that it eliminates collection call, letters, etc) and second, the creditors receive the agreed sum without additional effort on their part, saving the time and expense of collection activities. In addition, the increased rapport between customers and the creditors because of the creditors' willingness to work with the customers through the agencies manifests itself in extra effort by the customers to keep up with the plans, thus benefiting all involved.

That being said, there are two major problems affecting the counseling industry today: quality and quantity of DMPs. From a quality standpoint, many of the agencies in the industry today have little or no standards to ensure fair and ethical treatment of clients and creditors; many employ “counselors” with little or no training in credit counseling; some agencies actually manage and control their “counselors” as if they were sales people or telemarketers; many agencies “pick and choose” which debts they list on DMP applications, based upon whether or not particular creditors will pay “Fair Share;” some large agencies advertise that customers can have their debt problems resolved in as little as 10 minutes. That isn't even enough time to record the pertinent personal information and financial data of the applicant in most instances, let alone financial data, to say nothing about conducting “counseling.”

With respect to quantity, because of non-existent or sub-standard counseling, or because DMP applications are deliberately sent to creditors listing only those who support plans, without regard to the applicants' true financial status, the volume of DMPs in the industry has grown exponentially in recent years. This volume growth has far outpaced account growth, delinquent account growth, and bankruptcy growth rates in the consumer credit arena. One major creditor advised that in a recent year, their growth in DMPs was more than twice the growth they experienced in delinquent accounts. Historically, these rates tended to move in tandem.

Despite certain administrative and legal actions taken in recent years by consumer advocate groups and states' attorneys general against certain high profile agencies for egregious dealings with consumers, there still are large numbers of agencies operating in the industry who are continuing their self-serving business practices, at the cost of hurting consumers, alienating creditors, and damaging legitimate agencies trying to fill a need. In addition to a virtually universal reduction of “Fair Share” rates, (now down to about 7%) to combat the industry problems, creditors are seeking ways to better manage agencies, DMP applications, information flow, and the trade-off between concessions to customers and account performance. Cognizant of the mid-90s lawsuit, creditors have been reluctant to refuse to do business with counseling agencies, but realize with greater certainty over time that quality of operations and personnel varies to wide extremes across the industry.

The consumer credit industry in the United States has nurtured and supported credit counseling for half a century, at the cost of billions of dollars. While it is true that creditors benefit from the results attained by credit counseling agencies, it is also true that creditors want to support their customers who, generally through little or no fault of their own, get into financial difficulty. Creditors value their customers, and want them to become financially healthy when they experience downturns. Altruism aside, it is good business for creditors to take this approach, for often the alternative results are delinquency, credit losses, and bankruptcy. Given the upheaval in the credit counseling industry over the past decade, however, the relationship enjoyed for years between creditors and the industry is in peril. Further deterioration will force more legitimate agencies to cease offering service, and will exacerbate the problems at hand, all to the detriment of consumers, one way or another.

Due to the turmoil of recent years in the credit counseling industry, creditors have greatly reduced their historical level of support to the industry, imperiling the fiscal stability of most legitimate players, and risking incremental credit losses that would not have been incurred with a healthy industry providing a valuable service. Furthermore, creditors have little confidence in the industry's ability to resolve quality issues internally as they recognize that the industry is severely fragmented, with no dominant member or group of members able to lead reform efforts. Without a viable credit counseling industry serving consumers and creditors alike, there may be a movement among large creditors to abandon the industry, opting instead to work directly with their own troubled customers.

This would have a deleterious effect on the customers, however, as history has shown people in severe financial difficulty are more likely to benefit from the support offered by agencies that handle all their unsecured debt obligations, than continuing to struggle to appease individual creditors. Without the psychological lift received when the burden of multiple credit problems is alleviated, consumers struggle further, often unsuccessfully. The notion of a financial “lifeline” assisting consumers facing debt problems is a very real benefit derived from working through quality agencies. Any reduction or elimination of this type of support to consumers will have negative consequences for the creditors.

In light of this state of affairs, there clearly is a need for a system that will enable creditors to better manage credit counseling agencies, the accounts they propose to put on DMPs, and the level and duration of concessions sought from creditors. At the current time, there is no system being used in the credit industry that meets these needs. As stated above, input from agencies to creditors varies widely in form, substance, and quality. Some creditors, at considerable cost in terms of staff and other resources, have begun “underwriting” DMP proposals, but attempt to offset this added expense by reducing overall agency support. In addition, it has yet to be shown that their efforts pay dividends because the input varies so widely. Accurate comparisons of one agency versus the next are almost impossible. Most creditors, however, continue to rely upon the professionalism and good will of the agencies to perform the right type of counseling before forwarding DMP proposals, a position they recognize is suspect. These creditors pay for the additional volume by reducing levels of support, a policy that is bound to be self-defeating.

The credit counseling industry is highly fragmented in many ways. Even in the mundane areas of internal application processing, record keeping, and payment remittances to creditors, there are many processes used. There are at least five different, somewhat generic systems that agencies use for internal processing, plus unknown numbers of proprietary systems. As for payment processing, much of which is now managed electronically, both the MasterCard and VISA organizations have products widely in use throughout the industry, but there also are others. There is no consensus in the industry either about operating standards, training of counselors, certification of counselors and managers, fiscal policies, insurance and audit requirements, etc. It is an industry waiting for leadership and suffering for lack of high quality, standardized, business-like best practices.

### OBJECTS OF THE INVENTION

The industry needs as described above can be met by the system of the present invention through input standardization of DMP proposals, quality controls, decision-making rules, and data analysis. Further benefits derived through use of the system include the ability to judge agencies competitively against the same set of rules; an enhanced ability to ascertain the merits of individual cases; the capability to determine the amount and duration of concessions appropriate to each situation and reduced operating costs.

Many of the benefits associated with the methodology of the present invention flow from the standardization inherent in the process, including the ability of the users to analyze results of their decisions and perform controlled tests of strategy changes. In today's environment, agencies forward DMP proposals to creditors in varying formats, with differing amounts of information, via electronic media, fax, and mail. The system of the present invention is web-based, with standardized, mandatory input fields, as well as discretionary fields to be used as appropriate to the creditor's desires. Additionally, in a preferred embodiment, certain data must be validated by the counselor submitting the plan, lending credence to a process now rife with conjecture. Each creditor using the system has the ability to establish its own guidelines for application acceptance, as well as the power to control algorithms used for decision-making in line with the creditor's internal policies.

The creditor community and legitimate, well-intentioned members of the credit counseling industry need such a system and methodology to be able to continue to offer counseling and support to the millions of individuals and families seeking help each year. Without such a system available, creditors are likely to experience ever-increasing volumes of questionable DMP proposals, increasing their costs out of proportion to credit growth, thereby jeopardizing the creditors' willingness and ability to continue funding an industry whose value has become suspect. Unfortunately, as that happens, consumers who should have access to the proven benefits of quality credit counseling will be precluded from receiving it. In the end, without a strong system upon which creditors can properly evaluate input from the credit counseling industry, consumers, creditors, and legitimate agencies will be harmed.

### BRIEF DESCRIPTION OF THE DRAWINGS

FIG. 1 is a flowchart illustrating the overall process of the present invention in a preferred embodiment thereof;

FIGS. 2a and 2b are collectively an exemplary screen shot of the Creditor Supervisor's Menu;

FIG. 3 is an exemplary screen shot showing the results of a search for a credit counselor;

FIGS. 4a and 4b are exemplary screen shots showing the add a Counselor function;

FIG. 5 is an exemplary screen shot showing the Current Applications function;

FIG. 6 is an exemplary screen shot showing the results of a Search/List of Credit Counseling Agencies function;

FIG. 7 is an exemplary screen shot showing the Modify Counseling Agency Record function;

FIG. 8 is an exemplary screen shot showing the Creditor Employee Menu;

FIG. 9 is an exemplary screen shot showing the Add/Modify a Creditor Employee function;

FIG. 10 is an exemplary screen shot showing the Selection of mandatory data fields function;

FIG. 11 is an exemplary screen shot showing the Processing options function;

FIG. 12 is an exemplary screen shot showing the function for entering variables for Fair Share Calculations;

FIG. 13a is an exemplary screen shot showing the Modify the weightings of the DMP Algorithm function;

FIG. 13b is an exemplary screen shot showing the Setting limits on the DMP Algorithm function;

FIG. 14 is an exemplary screen shot showing the Add or Edit a credit counseling agency's manager function;

FIG. 15 is an exemplary screen shot showing the Agency Manager's Menu function;

FIG. 16 is an exemplary screen shot showing the Credit Counselor's Menu;

FIG. 17 is an exemplary screen shot which may be used to begin a new client record by entering the social security number;

FIGS. 18a, 18b, 18c and 18d are exemplary screen shots showing the screens which may be used to enter Client's Personal Data and Job information;

FIGS. 19a, 19b and 19c are exemplary screen shots showing the screens which may be used to enter Client's Budget;

FIG. 20 is an exemplary screen show showing the screen which may be used to enter Client's Unsecured Debt;

FIG. 21 is an exemplary screen show showing the screen which may be used to enter Clients Income;

FIG. 22 is an exemplary screen show showing the screen which may be used to enter Client's Assets;

FIGS. 23a, 23b, 23c and 23d are exemplary screen shots showing the screens which may be used to create The Debt Management Plan;

FIGS. 24a, 24b, 24c, and 24d are exemplary screen shots showing sample DMP report pages;

FIG. 25 is an exemplary screen shot illustrating the Credit Counselor's signature page;

FIG. 26 is an exemplary screen shot illustrating the first page of a client's (debtor's) entry form;

FIG. 27 is an exemplary screen shot illustrating the page for entry of address information of a client's (debtor's) entry form;

FIG. 28 is an exemplary screen shot illustrating the budget page of a client's (debtor's) entry form; and

FIG. 29 is an exemplary screen shot illustrating a page for entering unsecured debts of a client's (debtor's) entry form.

FIG. 30 is an exemplary screen shot illustrating a page for entering income of a client's (debtor's) entry form.

FIG. 31 is an exemplary screen shot illustrating the first page of a client's (debtor's) entry form after gaining an approved DMP.

FIG. 32 is an exemplary screen shot illustrating a payment page of a client's (debtor's) entry form after gaining an approved DMP

### DETAILED DESCRIPTION OF THE INVENTION

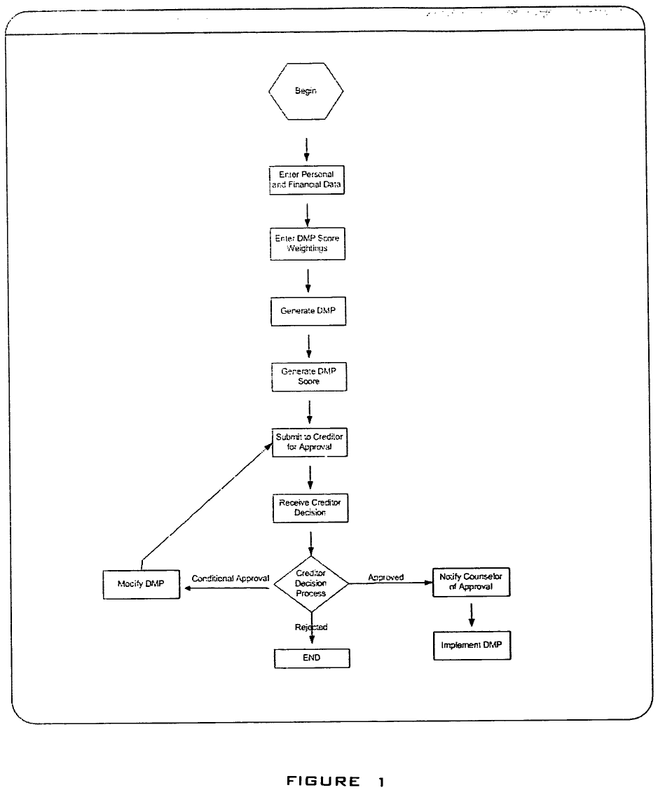

The present invention is now described in connection with the attached figures. Referring to FIG. 1, a flowchart illustrating the overall process of the present invention is provided. The process for creating and processing a debt management plan is now described at a high level with further details being provided below. First, in connection with the creation of a DMP, a credit counselor working with a client debtor enters personal information regarding the debtor. In an alternative embodiment, the debtor may enter personal and financial information online prior to or after initiating contact with a credit counselor. As described in detail below, this information should include all information that is required or desired by all of the collective creditors to whom it is expected that the DMP may be submitted. Once personal information has been entered, particular financial information concerning the debtor is next entered. This data is preferably obtained and/or confirmed by the credit counselor through a personal or telephonic interview with the debtor or via a web-based application with a user interface permitting the debtor to enter the information his or herself for review by the credit counselor. The financial information may include, for example, (i) outstanding debts of the debtor including balances and monthly payments; (ii) existing assets held by the debtor including notes concerning these assets such as availability for satisfying debts, etc; and (iii) recurring income available to the debtor through, for example, jobs, dividends, alimony payments, etc.

Based upon the information provided above, the system of the present invention permits the development of a proposed DMP. The proposed DMP is generated by the credit counselor using the system and taking a number of factors into account as more thoroughly discussed below. For example, the proposed DMP should be designed such that (i) it is likely to be acceptable to the applicable creditors, (ii) it is realistic in terms of what the debtor can afford to pay and (iii) it meets with general industry standards and practices for DMPs. According to a preferred embodiment of the present invention, the proposed DMP may be developed and modified by the counselor in a number of ways based upon personal knowledge, experience or particular issues with the specific debtor. For example, the counselor can modify the particular monthly payment amounts that are made to each of the creditors included in the DMP. The system may alternatively generate a default DMP which requires no input from the counselor although it preferably allows the counselor to modify such a default DMP as required and/or desired.

In addition to the DMP plan itself and the associated payments proposed, the system of the present invention also generates a proprietary DMP score associated with the DMP. Various algorithms for generating the score may be used as discussed in greater detail below. In a preferred embodiment, the factors associated with the determination of the DMP score are adjustable and individually definable by each creditor based upon the relative importance of various factors as desired by the creditor. The system weights these factors as entered into the system by the creditor or the credit counselor in connection with the determination of a DMP score for each DMP submitted to a creditor. In a preferred embodiment, a default DMP score may be assigned by the system with a predetermined algorithm and predetermined weighting factors. In the absence of a creditor supplying weighting factors in the case of a creditor desiring the default algorithm and weighting factors, the DMP score associated with the particular DMP and submitted to such a creditor will simply be the system default DMP score.

Once the DMP has been generated, the counselor may review the same and adjust it as necessary. When the counselor and client (debtor) are satisfied with the DMP, the counselor may submit it for creditor approval. Various embodiments for submission are possible. In one case, the system may automatically transmit the DMP and the DMP score for each particular creditor to each of the creditors included within the DMP. This is based upon available configuration data for each participating creditor. For example, the system may, in one embodiment, email the DMP and a custom DMP score for the creditor to each creditor at a predefined email address for each creditor for further processing. Alternatively, emails for each specific creditor may be manually selected by the counselor for transmission by the system to each particular creditor at specific times as desired by the counselor.

While the above embodiment with respect to generation and transmission of DMPs is most certainly an improvement over the prior art, it is not the preferred embodiment of the present invention in that all of the possible advantages of the present invention are not obtained. In a preferred embodiment, the system is implemented in software and resides on a centrally located server that is accessible by both the counselors and the creditors via password-protected access. In this way, when DMPs and DMP scores are generated by the system for the counselor they are stored in a database for access by the creditors at the appropriate time. Creditors may be notified by, for example, an email generated by the system each time a new DMP or batch of DMPs is made available for creditor processing. The advantage of this embodiment is that the system of the present invention may further operate to process the DMP from the creditor standpoint.

In that case, a creditor representative may access the DMPs and scores in the system database and either accept them or reject them based upon the DMP score and/or the particular proposal features contained in the DMP. Alternatively, the system may be designed for automatic DMP approval processing based upon specific criteria including, for example, the DMP score and/or other factors associated with the particular DMP. In this latter case, the system preferably includes an interface that allows each participating creditor to specify (and periodically review and/or update) the parameters for acceptance, conditional acceptance or rejection of DMPs. Additionally, it is possible for creditors to configure the system to provide automatic approval/rejection processing with the ability for manual override by an employee of the creditor.

Based upon creditor action, the counselor may be notified by the system as to the status of each submitted DMP. If accepted, the DMP is implemented via the counselor. Alternatively, if rejected, the counselor may opt to revise the DMP for new consideration or abort it altogether. It is also possible that one or more creditors may have conditionally accepted the DMP. In this case, the counselor in consultation with the debtor may choose to accept the conditions and modify the DMP accordingly for resubmission or reject the conditions and abort the DMP.

In a preferred embodiment, the system of the present invention offers a mechanism whereby the debtor may make monthly payments directly to the creditor(s) or to the credit counseling agency. In a preferred embodiment, creditors may establish rules for payment of a “fair share” to the credit counseling agencies. The system disclosed herein will calculate such a fair share for each debtor's payment. Counseling agencies may make monthly payments of collected funds less calculated fair share to creditors for single DMPs or in a batch mode. Payment history for each debtor is available online to both the credit counseling agency and to the creditor as well as to the debtor.

Now that an overview of the process has been provided, the particular details of the system and methodology of the present invention are presented in connection with the referenced figures. The following description represents the features and operation of the present invention in various possible preferred embodiments thereof. It will be readily recognized by one of skill in the art that the operation of the system of the present invention is not necessarily limited to the particular embodiments discussed herein.

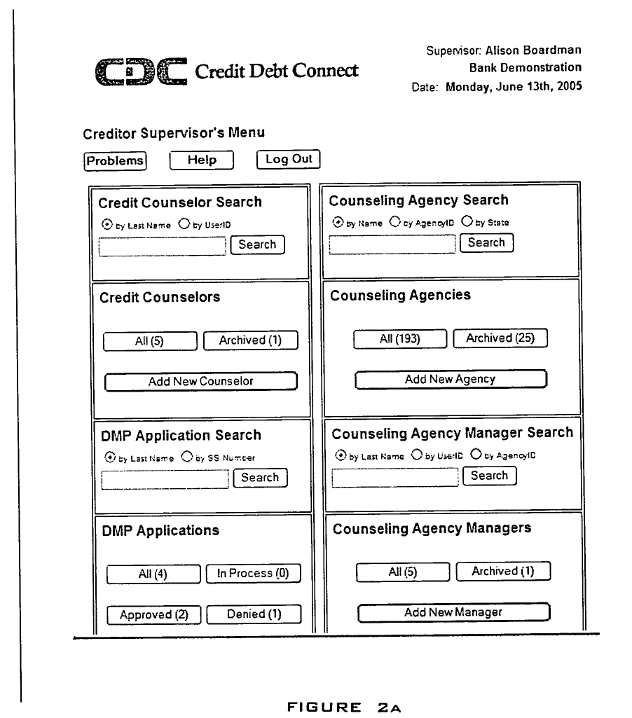

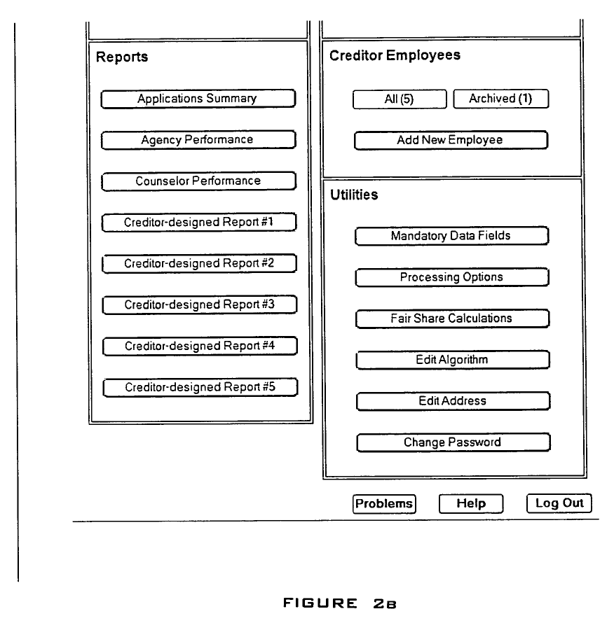

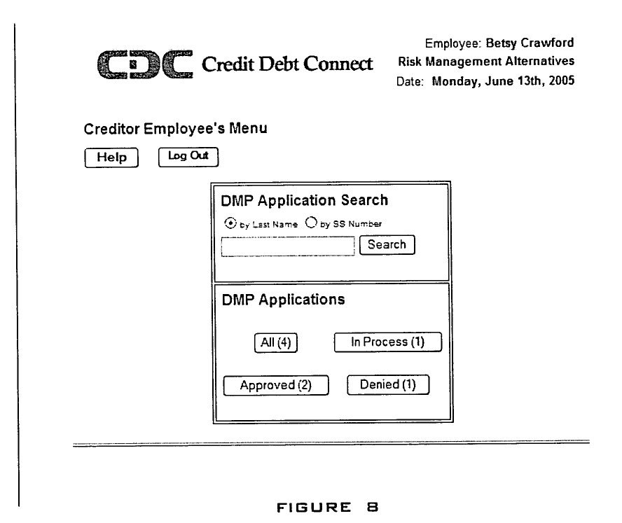

Turning now to FIGS. 2-11, a discussion of the system of the present invention and various features and related administrative functions in a preferred embodiment from the point of view of a creditor is provided. FIG. 2 is an exemplary user interface screen illustrating various features available to a supervisory employee of a creditor. As can be seen, various exemplary functions are presented to the user. Each of these is now discussed.

1—Problem Button—the system administrators may be contacted for technical support by pressing the problem button. The system presents a form for the submission of a request for information.

2—Help Button—additional information on usage may be accessed by pressing the help button. The system presents “help” within a dedicated Knowledge Base that can be searched by words or phrases entered by the user. The Knowledge Base has provision for user comments to be attached to found information as well as for the addition of “knowledge” by both users and managers.

3—Log Out—FIG. 2 shows a screen which is displayed after the creditor supervisor logs in. The log out button may be used to log out. This button is present on all pages and should be clicked whenever the user is leaving the system. This will prevent access to client records by others who may gain access to the user's computer. In addition, the connection to the system will “time out” after a period of inactivity.

4—Credit Counselor Search—individual credit counselors which have been entered into the system may be searched by name or user id.

5—Credit Counselors—the All button will display all of the available counselors which have been “registered” into the system.

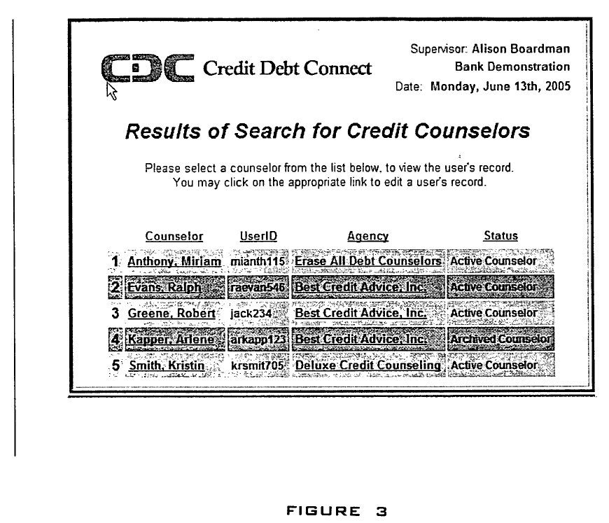

FIG. 3 is an exemplary screen which lists counselors which have been registered. As can be seen, the counselor's name and user id for each counselor is listed along with the agency with which they are associated. Status is also shown. Credit supervisors have the authority to “activate” and “deactivate” individual counselors and/or agencies over time. An inactive counselor or agency can not submit DMPs through the system although it is preferable that all DMPs for inactive counselors are archived for later access if necessary. The screen illustrated on FIG. 3 may also contain hyperlinks that lead to additional pages with additional information such as all counselors associated with an agency and other details of the agency including address, telephones, and contacts (by clicking on the agency text) or specific information about the counselor (by clicking on the counselor name).

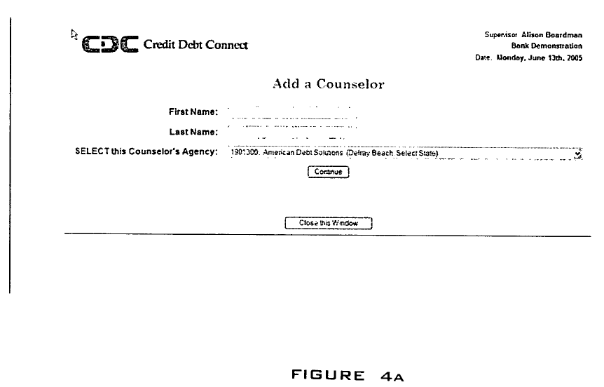

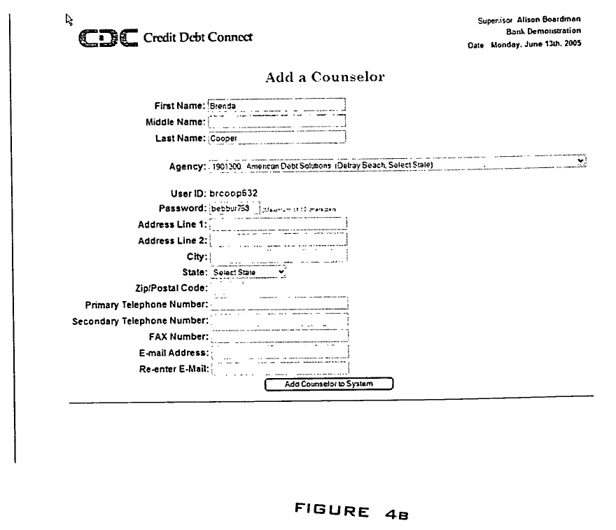

The screen on FIG. 2 also permits a creditor supervisor to list archived counselors as well as adding new counselors. An exemplary screen for adding new counselors is illustrated in FIG. 4.

6—DMP Application Search—this box allows the user to search for any applicant (debtor) along with any associated DMPs for that applicant that have been submitted to the creditor. Search may be performed using either the applicant's last name or social security number.

7—DMP Applications—the All button may be used to list all pending and/or processed DMPs by applicant.

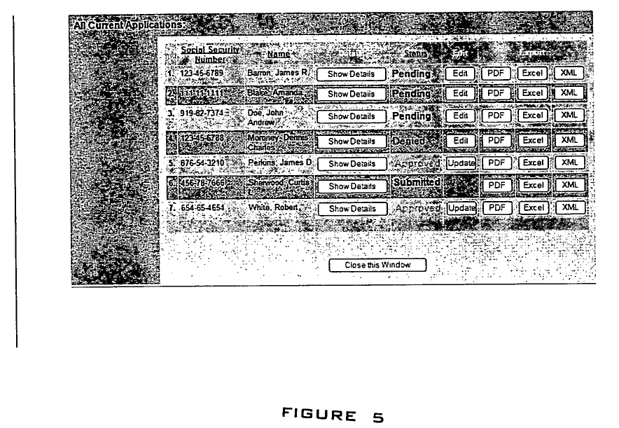

FIG. 5 is an exemplary screen shot showing a display that may appear if the All button is selected. In this embodiment, DMPs are listed by applicant and each applicant has an associated social security number for indexing. The date the application was received by the creditor (Date Submitted) and the current status of the application are also shown. More than one DMP may be associated with each applicant. By pressing the Show Details button from the screen on FIG. 5, the DMP may be displayed for review and manual processing. The screen illustrated on FIG. 5 may also contain hyperlinks or buttons to permit sorting by, for example, status such that all approved DMPs are the only ones listed or they are listed first. Similarly, hyperlinks may be available for displaying only rejected DMPs or only DMPs which are awaiting either manual or automatic approval/rejection determinations. Selected DMP applications may be exported from the system in PDF, Excel, XML or some other available format. In addition or alternatively, buttons in the screen illustrated on FIG. 2 may also be provided to list only approved, rejected and/or in-process applications.

8—Reports—Various reports are available to the creditor. The button, Applications Summary will present a screen containing summarized data of all of the DMPs submitted to the creditor with information regarding dates of submission, status, number denied, plans current, plans in default, due dates for yearly renewal, etc. Other buttons will present screens containing analysis of agency performance and individual counselor performance in terms of creditor action on submitted plans. In addition to these default reports, other, creditor-designed reports will be produced at the time of each creditor's registration in the system. These particular reports will be specific to a particular creditor.

9—Counseling Agency Search—this box makes it possible to search for registered credit counseling agencies by name or agency ID.

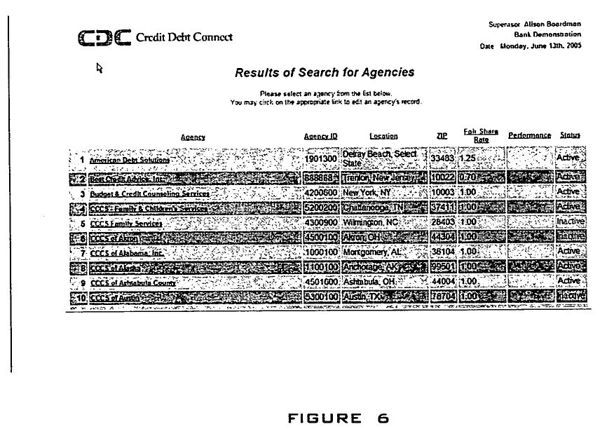

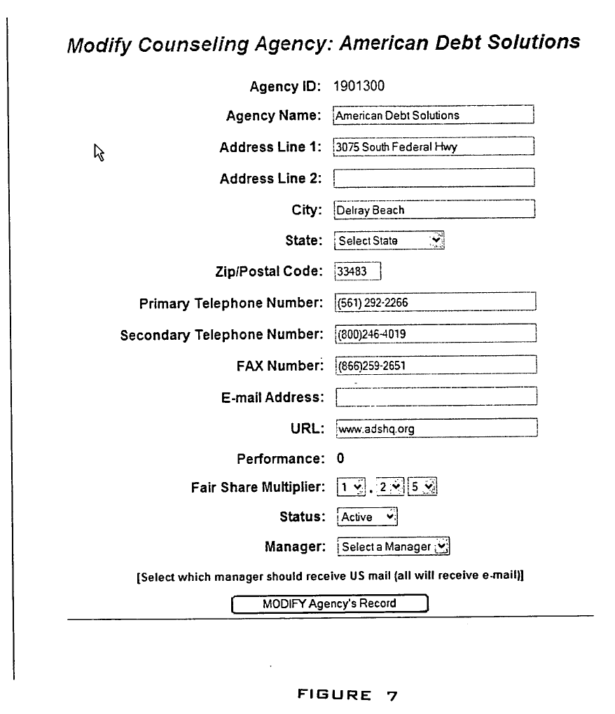

10—Counseling Agencies—using the List All button, all registered counseling agencies may be displayed. On the displayed page, data regarding each agency and its associated counselors may be reviewed and updated. FIG. 6 illustrates a listing of credit counseling agencies. Hyperlinks may be available for sorting the list of agencies by name, ID, location, ZIP, Fair Share rate, performance, or status. Credit counseling agencies can be reviewed for “Fair Share” and for “Performance.” Variables can be set by the Creditor to calculate fair share and/or performance. FIG. 7 provides an exemplary screen shot which may be displayed after the modify counseling agency link is pressed from the screen displaying all of the registered agencies. As can be seen, various data, including a multiplier for determining fair share rate, associated with each counseling agency may be viewed and/or modified. Archived counseling agencies may also be displayed using the applicable button in FIG. 2 and new agencies may be added along with associated counselors via the add new agency button in FIG. 2.

11—Counseling Agency Manager Search—the Manager Search function allows the credit supervisor to search for counseling agency managers either by name or user id.

12—Counseling Agency Managers—access privileges of managers and other personnel at the counseling agency may be controlled and new managers may be added by the creditor supervisor using the buttons in the Managers box. It will be understood by one of skill in the art that from a counseling agency point of view, multiple levels of access to the system may be available. For example, a manager may have access to review and manually submit or reject DMPs as well as having supervisory privileges such as adding new user ids for non-supervisory agency employees who themselves only have access to review and submit or reject DMPs, for example.

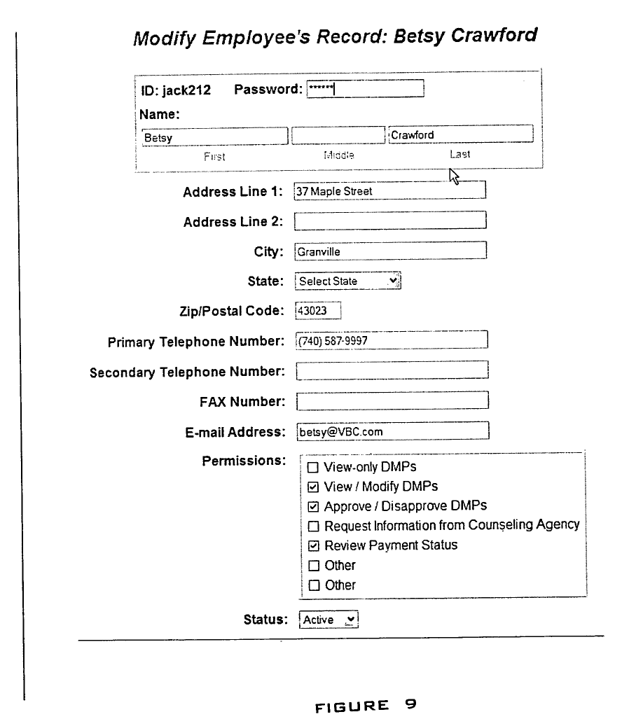

13Creditor Employees—access privileges of creditor employees and other personnel at the creditor may be controlled and new employees may be added by the creditor supervisor using the buttons in the Creditor Employees box. It will be understood by one of skill in the art that although not shown, another set of screens for interacting with the system are available to non-supervisory employees or consultants of the creditor as shown in FIG. 7. In general permissions will preferably be less such that, for example, non-supervisory employees may be permitted only to view, modify and submit DMPs for processing. According to a preferred embodiment, the specific permissions and user interfaces available to various classes of users is easily definable and modifiable by the creditor supervisor through the appropriate user interface screens, as for example as illustrated in FIG. 9.

14—Utilities—Several utilities are available for the creditor supervisor to control the behavior of the system.

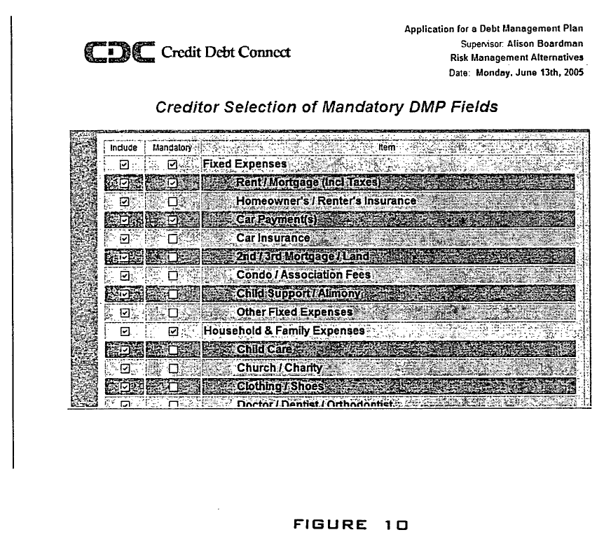

Mandatory Data Fields: Creditors may select which data fields are mandatory and/or even present at all. FIG. 10 is a portion of an exemplary screen through which a creditor, in this case a creditor supervisory employee, may specifically customize the data input screens

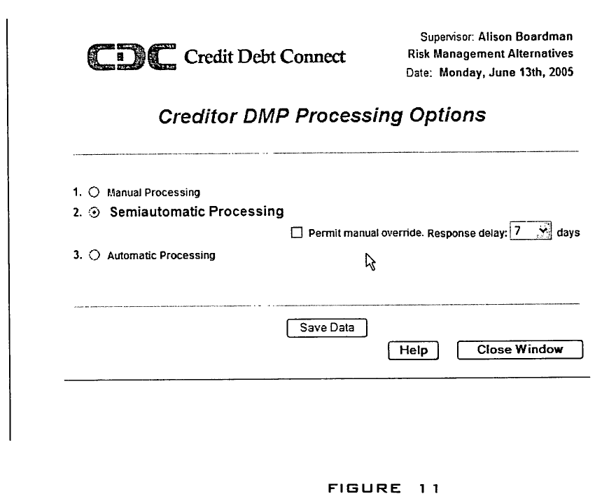

Processing Options: Various options for creditor processing of applications are available as may be selected by each particular creditor. In a preferred embodiment, the system is configurable to permit these variations in desired processing scenarios. For example, a creditor may desire that the system be configured so that as DMPs are received from agencies, they are automatically processed based upon set criteria such that an approval/rejection determination is automatically made and reflected in the system via the applicable user interface screen. Similarly, the system may periodically batch process a set of DMPs. In this automatic processing scenario, it is also possible to permit manual overrides of the acceptance or rejection based upon manual creditor employee review. An alternative configuration does not use automatic processing but requires human intervention and manual acceptance or rejection of each DMP at some point in time. FIG. 11 provides an exemplary screen shot which may be displayed after the creditor supervisor presses the button, Processing Options.

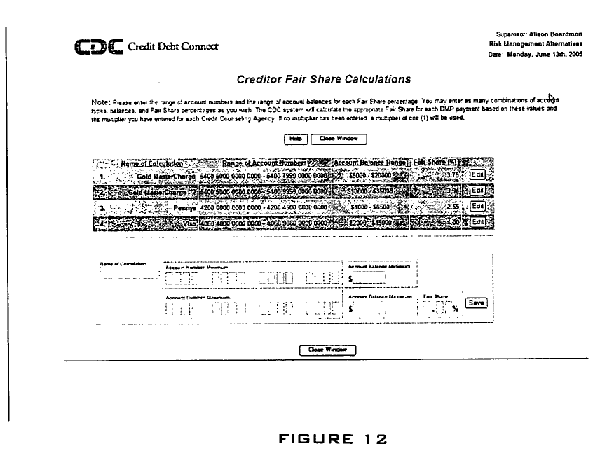

Fair Share Calculations: FIG. 12 is an exemplary screen through which a creditor may customize the percentage of fair share offered to credit counseling agencies. Creditors may specify different fair share rates based upon account types as specified by a range of account numbers. In addition, creditors may specify different fair share rates based on ranges of account balances. In a preferred embodiment, creditors may even establish a fair share rate for a single specific account.

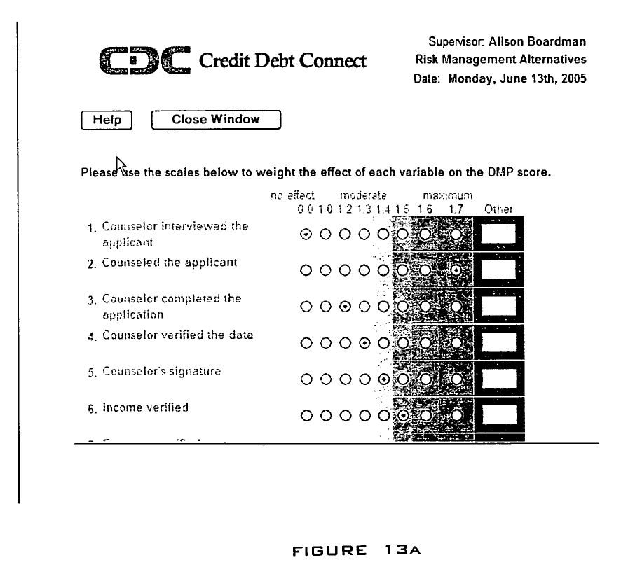

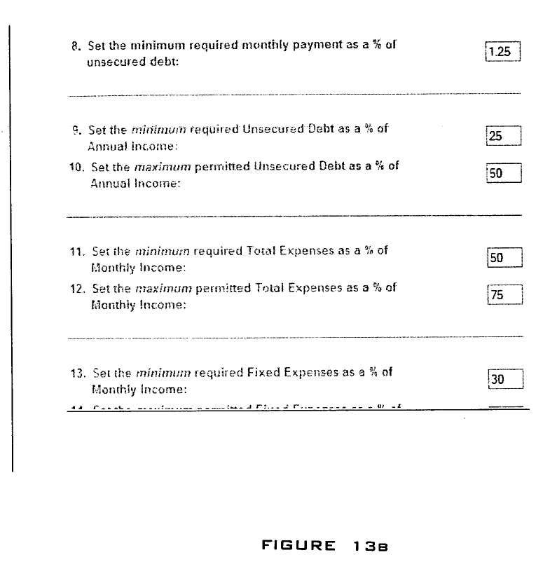

Edit Algorithm: Referring to FIGS. 13a and 13b, an exemplary screen through which a creditor, in this case a creditor supervisory employee, may specifically customize weightings to be used in calculating DMP scores to be associated with each submitted DMP. As can be seen from the Figure, various features may be controlled to impact the DMP score. For example, an initial set of true/false situations such as whether the counselor verified the data may be weighted according to creditor desires in the overall DMP score. In addition, various factors for minimum criteria, which if not met will result in automatic rejection of the DMP may be set. For example, a minimum monthly payment as a percentage of unsecured debt may be specified. In most cases, these weightings and minimum criteria will apply across the board to all DMPs received by the creditor although the system may permit different weightings and minimum criteria in various situations such as which agency submitted the DMP or when the DMP is submitted.

The system provides creditors with the option of loading the data of several thousand previously processed DMPs into the database to be used as baseline data for comparative studies on the effects of the processing algorithm. The system will produce comparison data showing the consequences of processing the baseline data with the default algorithm, the current algorithm settings defined by the creditor, and multiple “new” algorithm settings under consideration by the creditor. In this manner, the creditor can, at any time, alter the algorithm for use in processing future applications with such alteration based upon an empirical determination of consequences.

Now that interaction with the system of the present invention from the point of view of the creditor has been described, the present discussion will turn to the manner in which the counseling agencies and the individual counselors interact with the system and how they, in particular, prepare, review and submit DMPs for processing through the system of the present invention.

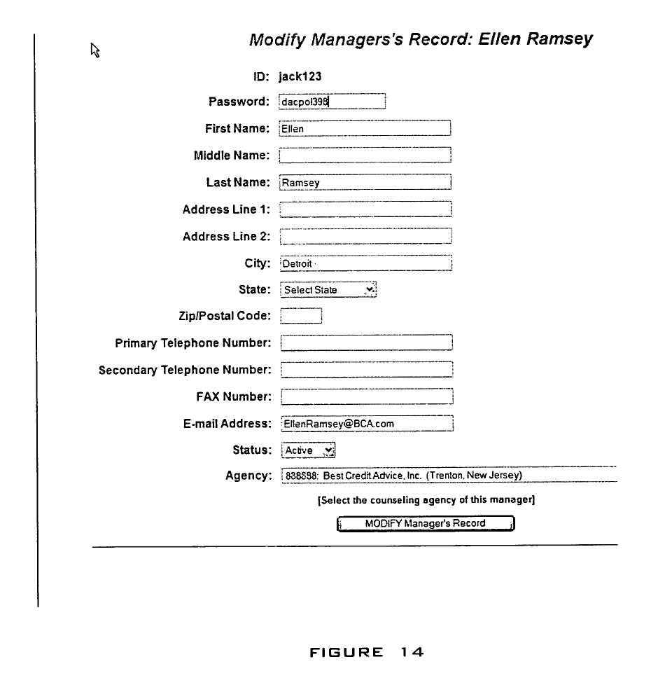

As with the creditor interface, various levels of access to the system are available as specifically configured by the particular counseling agency. For example, an agency may select one level for a supervisor which permits the creation of, viewing of and submission of DMPs as well as various supervisory options such as adding user ids for new credit counselors affiliated with that agency. These supervisors, herein known as Counseling Agency Managers, must be registered into the system by the Creditor Supervisor at the time of registering a credit counseling agency for use of the system. FIG. 14 is an exemplary screen through which a creditor supervisor can register and/or edit a manager for a credit counseling agency.

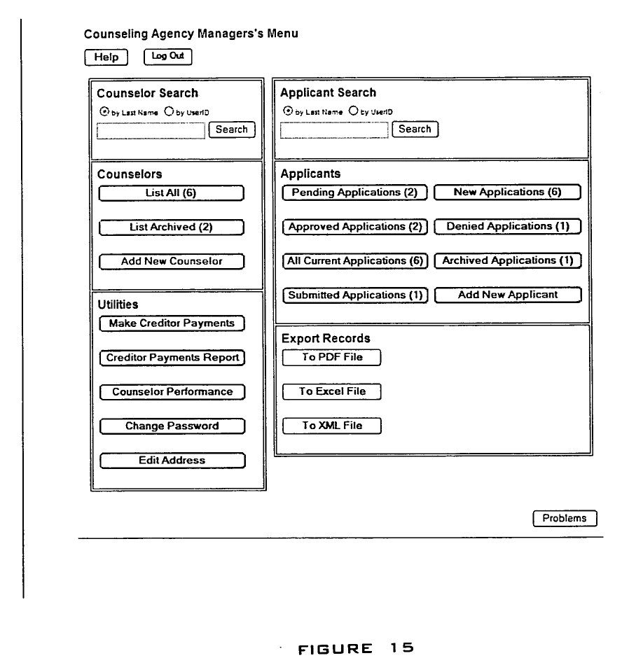

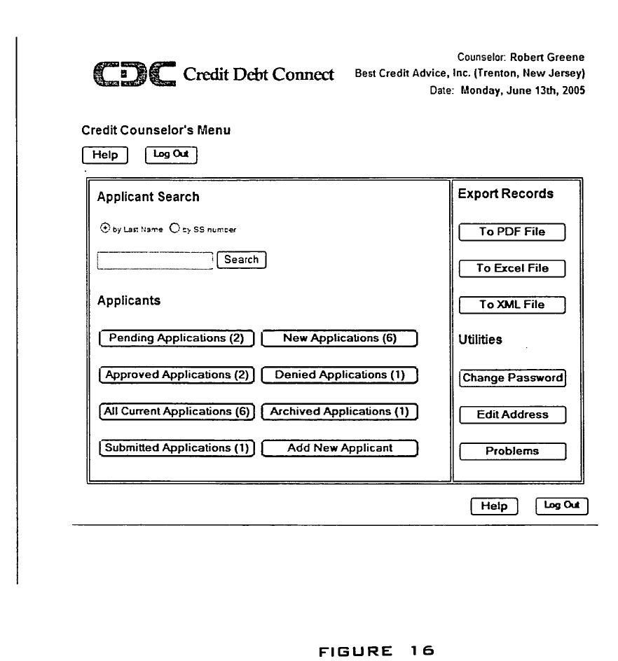

FIG. 15 is an exemplary screen through which a credit counseling agency manager can control the counselor and client data pertaining to his or her agency. Another level may be selected for the non-supervisory counselors which have authority only to create, access and submit DMPs. FIG. 16 is an exemplary screen through which credit counselors create and manage DMPs for their clients.

In most cases, counseling agencies will have either an implied or express relationship with each of the creditors to which they will submit DMPs. As discussed above, these relationships typically allow for the agencies to receive the “fair share” of collected amounts. In a preferred embodiment of the present invention, DMPs are automatically submitted to all creditors holding accounts contained within the DMP such that the counselor merely presses the submit button and the system automatically makes available the submitted DMPs to the appropriate creditors through the creditor interface as discussed above. Counselors, in addition, will be able to export a tab-delimited file of the client's data without any processing for use with creditors not registered with the system.

Referring now to FIG. 16, an exemplary screen through which a credit counselor may interact with the system is illustrated. As with other screens already discussed, help and logout buttons are available. Additionally, the counselor may search for applicants by name or social security number or by other criteria. These applicants may be sorted on the results page by various criteria through hyperlinks or buttons as desired. Multiple DMPs may be associated with a single applicant and these may be displayed in a nested fashion under the applicant's name on the results page. A counselor may have access to all of his or her agency's applicants or only to those assigned to him or her at the option of the agency manager.

The counselor may also select to view all applicants and/or DMPs via the applicable button. Some DMPs or applicants may be archived because they are no longer active in the agency's files. These may be viewed via the list archive button. An add new applicant button may be used to set up a new applicant and an associated DMP for that applicant. This procedure is discussed in detail below. Additionally on FIG. 16, various other buttons may be available such as the ability to change a password etc. In case of a supervisory agency employee, other functions may also be available such as functions which control setting up and controlling the access of non-supervisory employees.

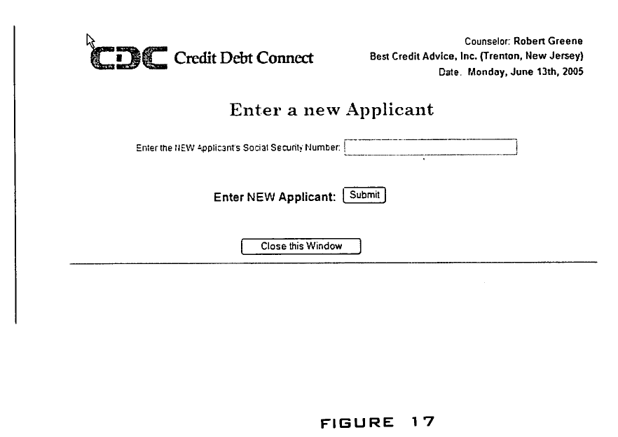

Starting with FIG. 17, the process by which a credit counselor enters and submits a DMP is now discussed in detail. By selecting the Add New Applicant button from the FIG. 16 screen, the counselor may be presented first with a screen such as that shown in FIG. 17 that permits the counselor to enter the applicant's social security number. The system then checks the database for a previously entered DMP and, if one is found, presents that DMP for editing. If no previous DMP is located, the counselor is presented with an empty data-entry screen.

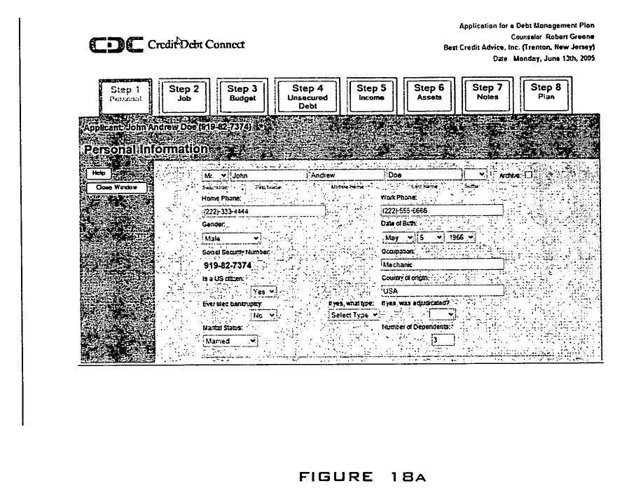

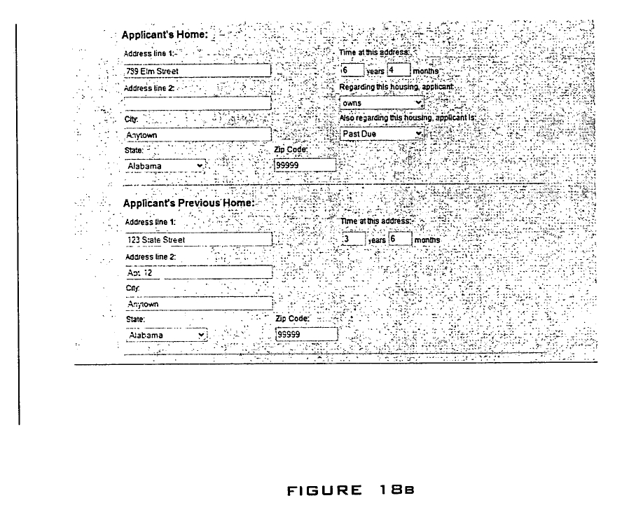

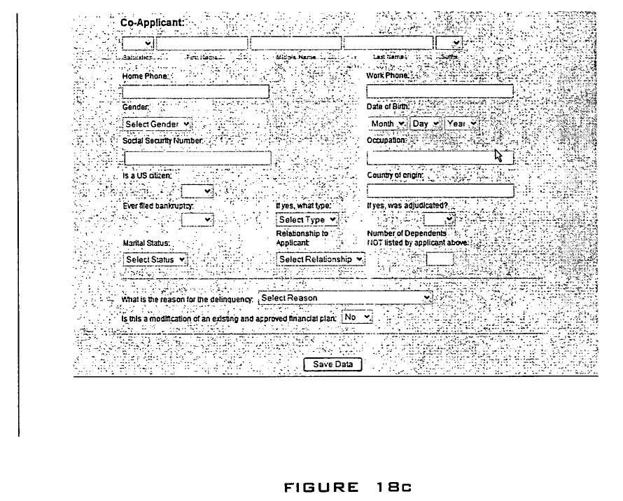

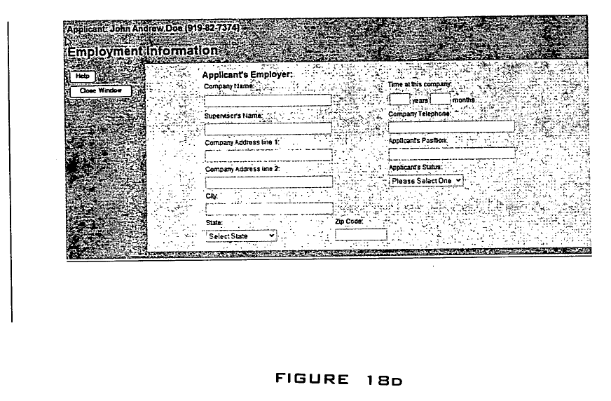

Once a social security number has been entered successfully, the first of the DMP entry screens opens as seen in FIGS. 18a, 18b, 18c, and 18c. As can be seen, the counselor is prompted to enter various personal information concerning the applicant (debtor). In this screen and others that follow, it will be recognized that some or all of the data fields may be made mandatory. The system may be configured by the creditor supervisor in this respect to ensure that minimum creditor requirements for data are met in connection with the submission of DMPs.

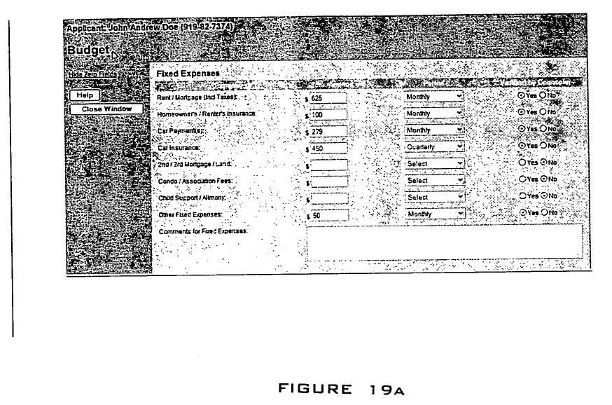

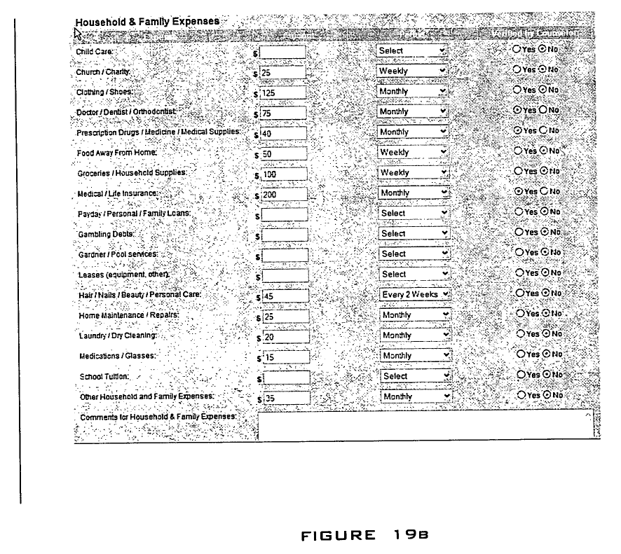

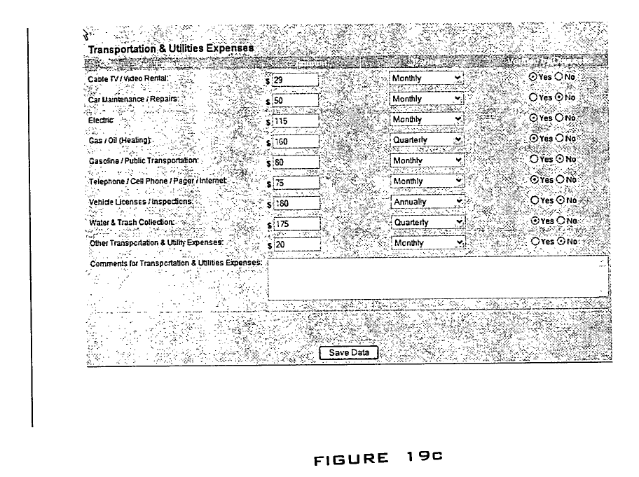

Once the counselor has met the minimum data requirements and pressed the “save data” or “accept” button, the system may proceed to a screen such as that shown in FIGS. 19a, 19b, and 19c whereby the counselor is prompted for information concerning the applicant's current budget. Various categorized entries for periodic expenses of the applicant are entered through this screen as shown.

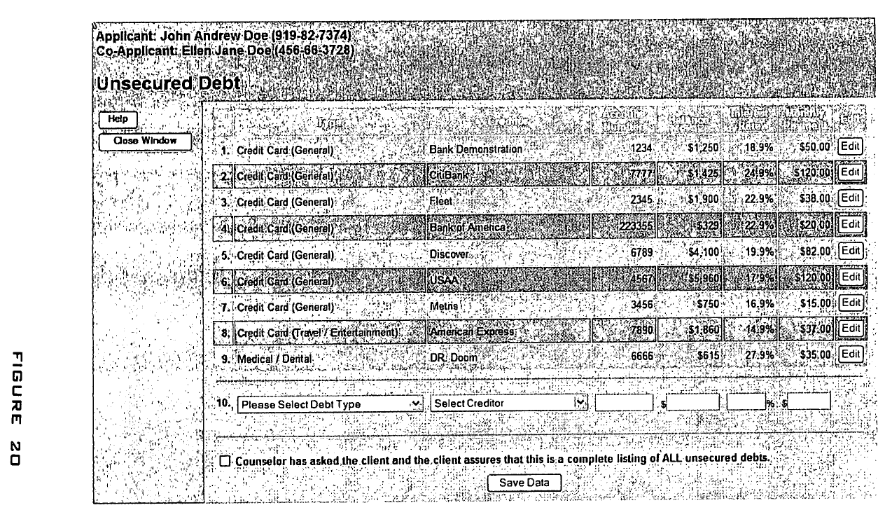

In step 3, the system may proceed to a screen such as that shown in FIG. 20, wherein the counselor is prompted to enter data regarding the applicant's unsecured debt which is to be addressed by this DMP. As can be seen, pull down menus and entry fields allow the counselor to enter as many debt entries as are required. The counselor is instructed to ensure that the client is reporting all of his or her unsecured debt and must so indicated by checking a box on the screen.

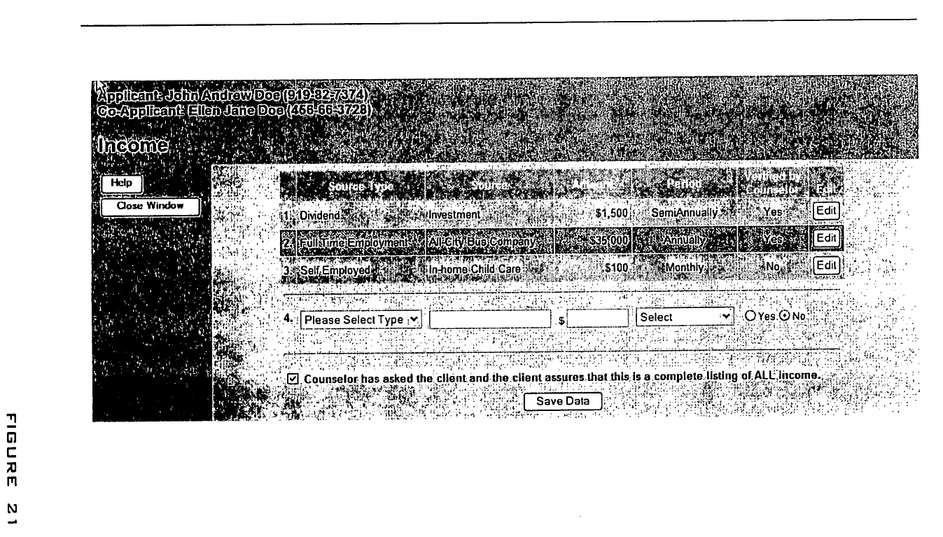

Once the debts have been entered and the save data button pressed, the system may proceed to a screen such as the one illustrated in FIG. 21. Through this screen, the counselor is prompted to add entries for each of the applicant's income sources such as employment, alimony dividends, etc. As can be seen, pull down menus and entry fields allow the counselor to enter as many income entries as are required. The counselor is instructed to ensure that the client is reporting all of his or her income and must so indicated by checking a box on the screen.

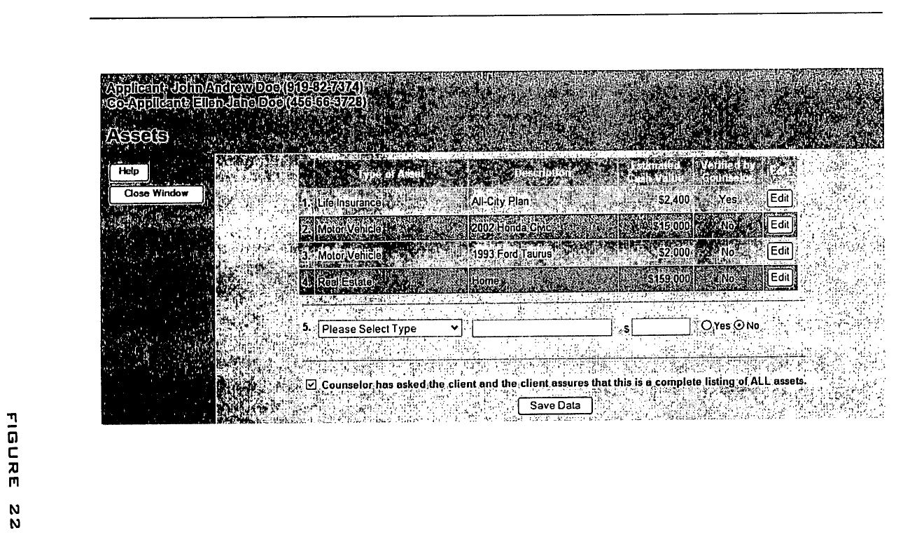

Once accepted, the system may proceed to an assets screen such as the one shown in FIG. 22. At this step, the counselor is prompted to enter assets belonging to the applicant along with descriptions and estimated value for each. As can be seen, pull down menus and entry fields allow the counselor to enter as many asset entries as are required. Although not shown, once the assets data is saved, a screen may optionally appear permitting the counselor to enter particular information that he or she wishes to convey in connection with the DMP such as notes about status of assets, willingness of the applicant to comply with the DMP, etc. The counselor is instructed to insure that the client is reporting all of his or her assets and must so indicated by checking a box on the screen.

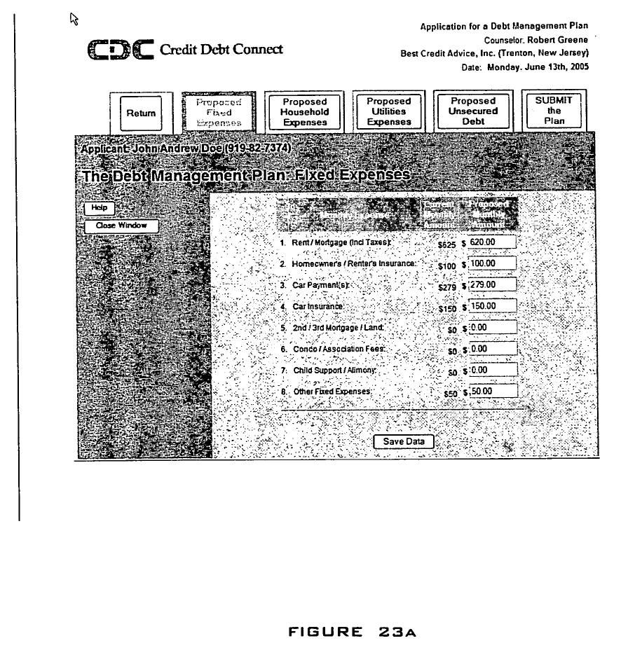

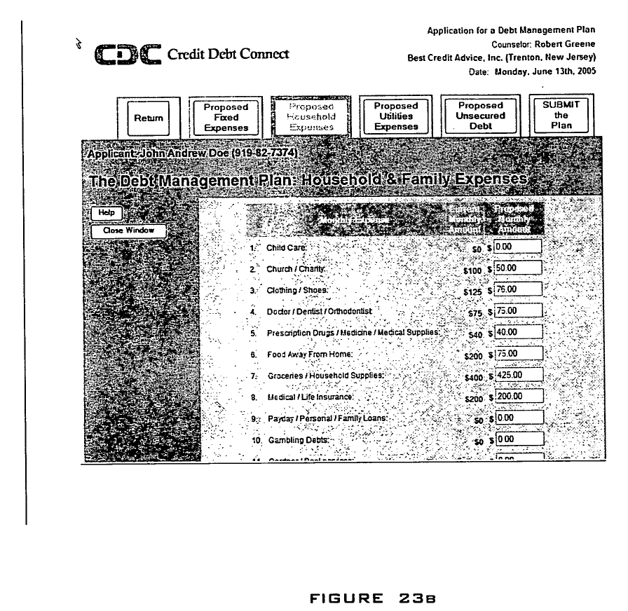

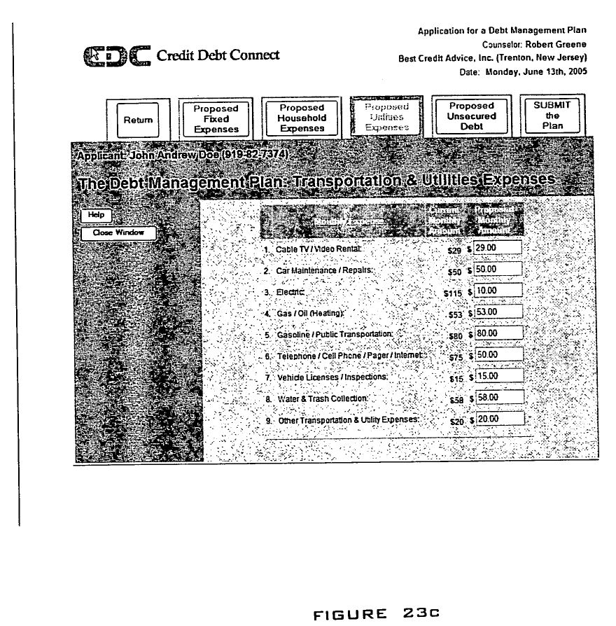

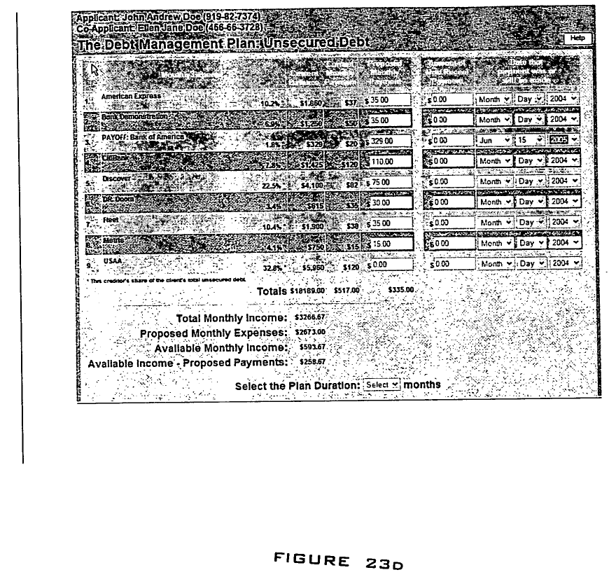

FIG. 23a shows an exemplary view of the first page of an exemplary DMP that is automatically generated by the system based upon the data entered by the counselor. Working together, the counselor and the client (debtor) can adjust the client's budget based upon advice provided during the counseling session(s) by the credit counselor. FIGS. 23b, 23c, and 23d illustrate the remaining parts of the DMP development screens. While the Fixed Expenses cannot be easily changed, the client can be advised to alter his or her spending habits in many other areas of the budget. The actual DMP is proposed by making adjustments to the payment schedules for the unsecured debt as shown in FIG. 23d. The counselor must be aware of the guidelines followed by each creditor when entering this plan. In a preferred embodiment of the system, payment limits, requirements, and percentages imposed by each creditor may be illustrated and enforced on the screen shown in FIG. 23d thus ensuring that the debtor and counselor produce an acceptable DMP.

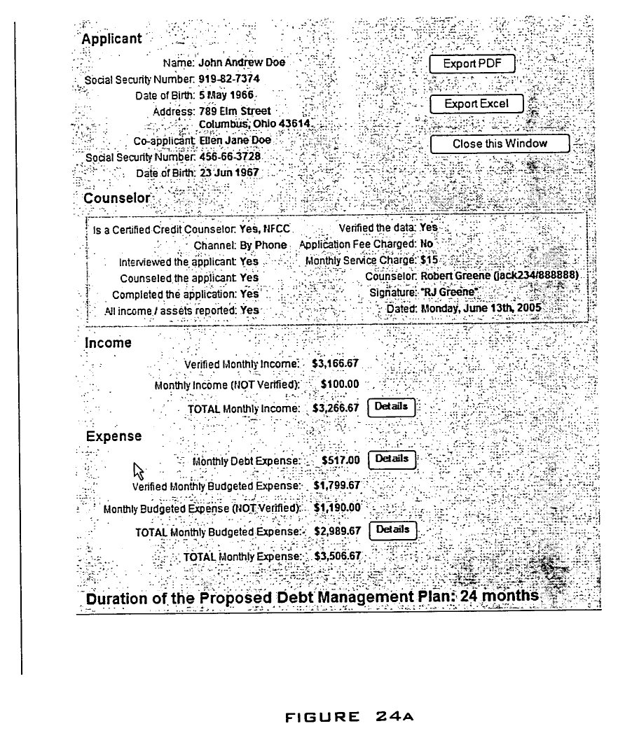

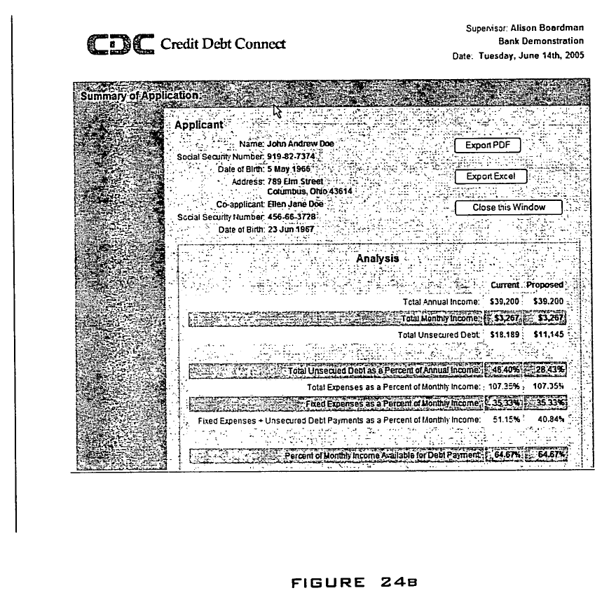

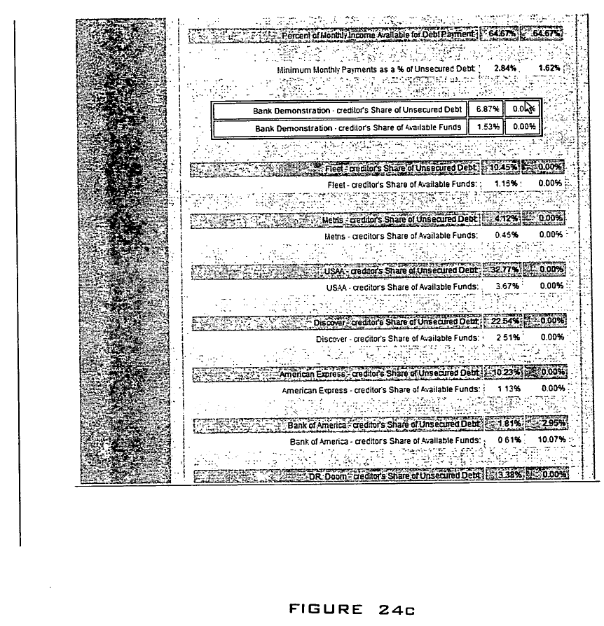

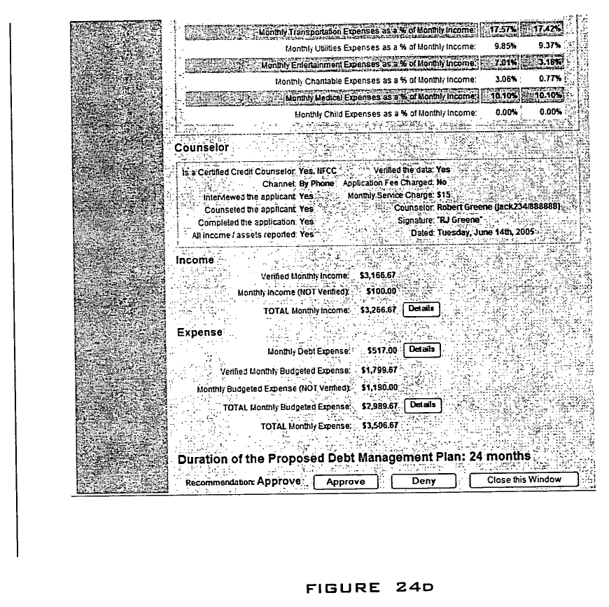

FIGS. 24a, 24b, 24c, and 24d are illustrations of screens that may be used to provide a summary of the DMP. These screens may also show the generated DMP score for the DMP calculated as described above. The score may pertain to a “default” set of weighting factors or it may be based upon the requirements of one or more specific creditors. This screen is available only to the creditor. As can be seen, the screens present the present financial data for the debtor and the proposed data. Items appearing in red are “flagged” because the values fall outside of the limits set by the creditor as described previously. FIG. 24d illustrates a preferred embodiment whereby the creditor may manually enter a decision regarding the acceptance of the DMP. As would be apparent to one of skill in the art, the exact nature of the reporting to a creditor will depend upon the needs of the creditor and may include direct loading into the creditor's database system, notification by email, or the establishment of additional screens for use by employees of the creditor.

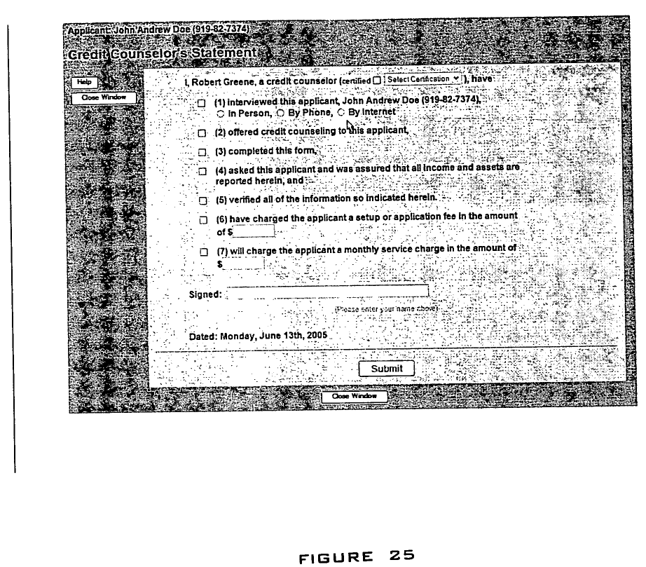

FIG. 25 is a screen through which the credit counselor is asked to certify to a number of facts as may be required by regulation, general industry practice or by one or more creditors. The credit counselor, if applicable, checks the appropriate boxes and then may submit the application directly to the creditors included in the DMP or some subset thereof. Preferably, the submission is date stamped for reference by both the counselor and the creditors.

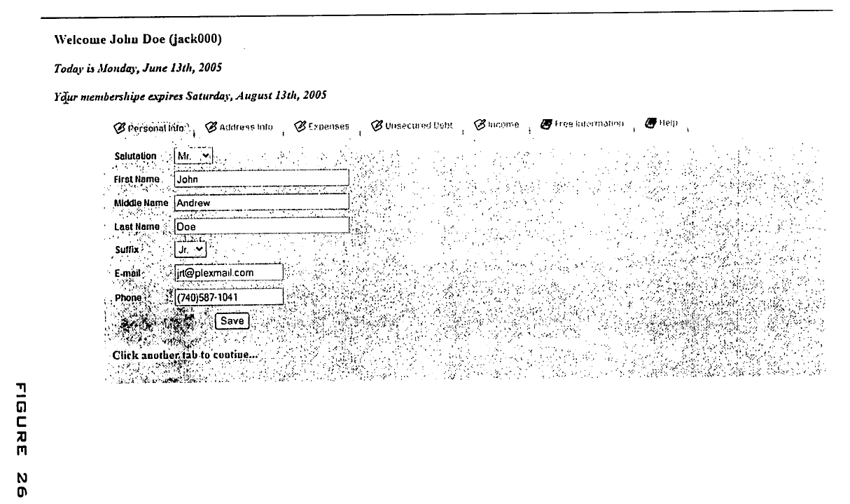

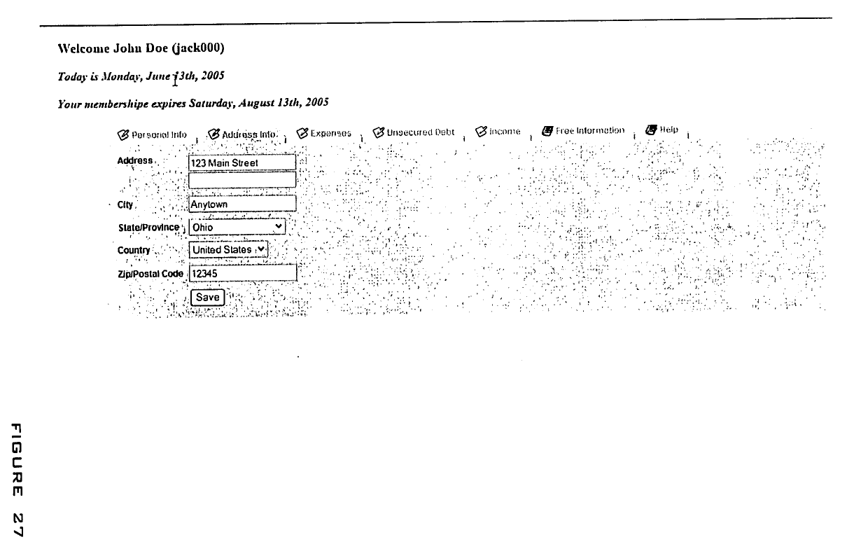

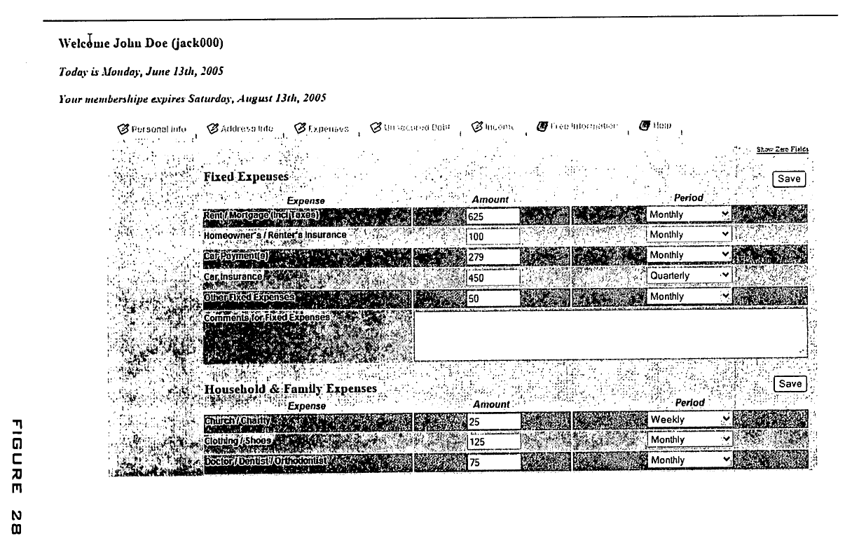

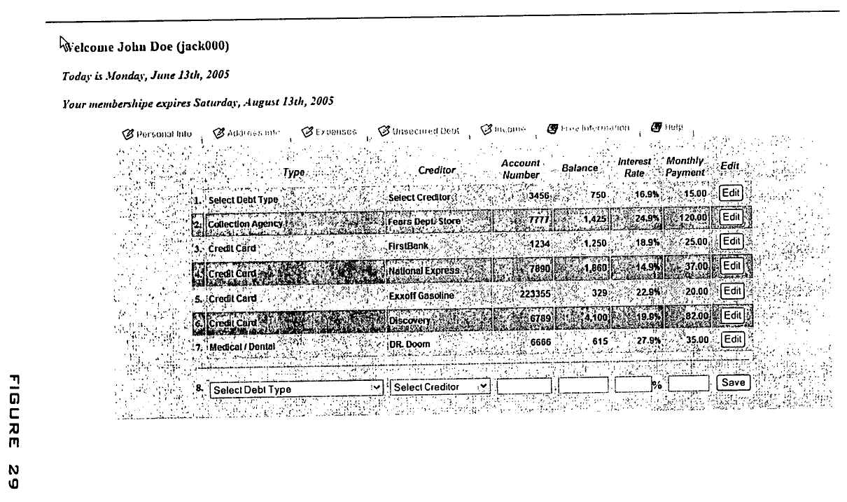

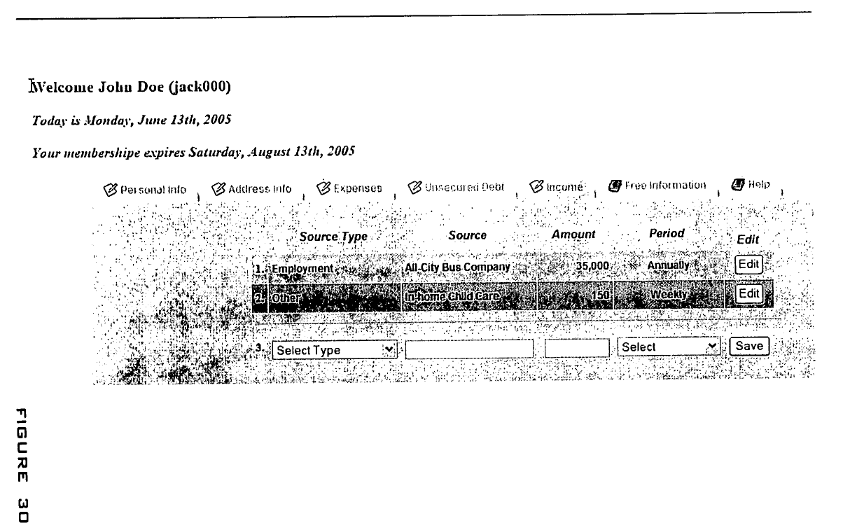

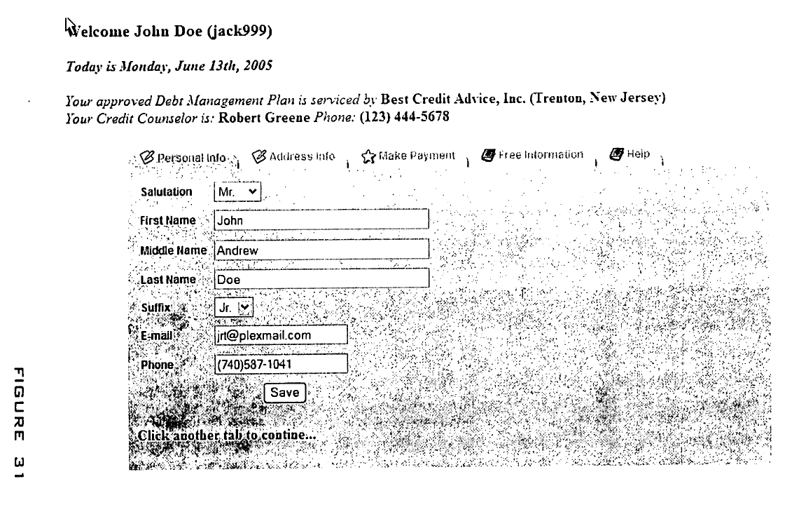

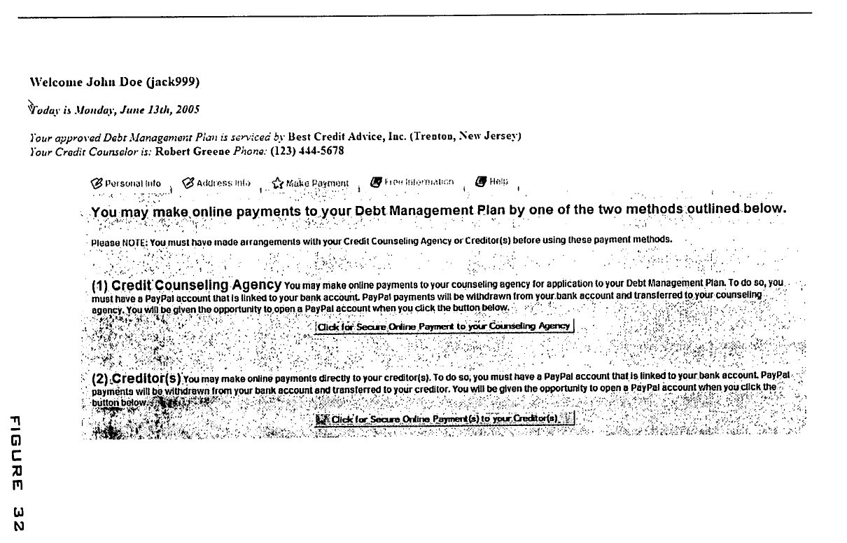

An embodiment of the present invention whereby a debtor may enter information online directly into the system for use by a credit counseling agency or a creditor is illustrated in FIGS. 26-32. In a preferred embodiment, a debtor may enter the requested information, undertake credit counseling with an agency, and, after acceptance of the DMP, make monthly payments to the credit counseling agency or directly to the creditor (see FIG. 32).

It will be understood that the present invention has been described in terms of particular exemplary embodiments thereof. Other applications are of course possible as would be apparent to one of skill in the art. By way of example only, the teachings included herein may be applied outside of the credit industry wherein submissions of data are submitted by one party to another. One example of this is in connection with mortgages wherein a mortgagor or his or her agent may submit data and possibly a “plan” to the entity holding the mortgage possibly for a request for a reduced interest rate based upon market conditions.

It will also be understood that it is not necessary for the system to be used by agents of one or more parties. For example, a debtor in the credit counseling embodiment described in detail above might enter data directly and submit it directly to one or more creditors without the involvement of a counselor if such a procedure is or becomes acceptable in the industry.

1. A method for processing a debt management plan for a debtor comprising the steps of:
entering personal information associated with said debtor into a database;
entering financial information associated with said debtor into said database;
generating a debt management plan for said debtor based upon said personal information and said financial information;
submitting said debt management plan to at least one creditor of said debtor, each of said at least one creditors holding an account referenced in said debt management plan;
awaiting approval or denial of said debt management plan from said at least one creditor;
upon receipt of said approval or denial from each of said at least one creditors, and in the event that said debt management plan is approved by said at least one creditor, implementing said debt management plan.

2. The method of claim 1 further comprising the step of determining whether any of said approvals from any of said creditors are conditional and wherein if any of said approvals are conditional, modifying said debt management plan in accordance with said conditional approvals and then implementing said debt management plan.

3. The method of claim 1 further comprising the step of generating a DMP score associated with said debt management plan.

4. The method of claim 3 wherein said DMP score is determined according to a predetermined algorithm and wherein weightings of a plurality of factors are used in association with said algorithm.

5. The method of claim 4 wherein said weightings are configurable by a debt counselor.

6. The method of claim 4 wherein said weightings are configurable by at least one of said creditors.

7. The method of claim 3 wherein each of said creditors applies said DMP score in accordance with its decision with respect of approval or denial of said debt management plan.

8. The method of claim 1 wherein a debt counselor is notified of said acceptance/denial decisions by said at least one creditor via email.

9. The method of claim 1 wherein said at least one creditor presets at least one determinant for automatically accepting or rejection said debt management plan.

10. The method of claim 9 wherein said automatic acceptance or denial may be overridden by said at least one creditor.

11. The method of claim 1 wherein said at least one determinant comprises a DMP score.

12. The method of claim 1 further comprising the step of said at least one creditor inputting specific fair share data in response to said debt management plan.

13. The method of claim 1 wherein at least one of said personal information and said financial information is entered into said database by said debtor via an on-screen user interface.

14. A debt management plan processing system comprising:
a user interface for entering personal and financial information associated with a debtor;
a processor for creating a debt management plan for said debtor based upon said entered personal and financial information;
a creditor interface, said creditor interface transmitting said debt management plan to at least one creditor for approval or rejection; and
an implementation module for implementing said debt management plan after said debt management plan has been approved by said at least one creditor.

15. The processing system of claim 14 further comprising a DMP score generator, said DMP score generator generating at least one DMP score to be associated with each said debt management plan.

16. The processing system of claim 15 wherein a plurality of DMP scores are associated with each said debt management plan.

17. The processing system of claim 16 wherein each of said DMP scores are calculated by said DMP score generator based upon at least one weighting selection by at least one of said creditors.

18. The processing system of claim 14 wherein said personal and financial information is entered by a debtor through an application interface available through the internet.

19. The processing system of claim 14 wherein each of said creditors determines acceptance or rejection of each said debt management plan automatically based upon at least one predetermined factor.

20. The processing system of claim 14 wherein said implementation module allocates a portion of any payment received by a debtor to a fair share payment made to a debt counseling agency.
